(19) United States
(12) Patent Application Publication
(10) Pub. No.: US 2007/0159990 A1
(43) Pub. Date: Jul. 12, 2007

(54) Method for detecting a wireless network signal

(75) Inventors: Po-Heng Wu, Taipei City (TW); Chien-Chi Fu, Taipei City (TW); Cheng-Po Liao, Taipei City (TW)

Correspondence Address: BACON & THOMAS, PLLC, 625 SLATERS LANE, FOURTH FLOOR, ALEXANDRIA, VA, 22314, US

(73) Assignee: D-Link Corporation, Taipei City (TW)

(21) Appl. No.: 11/327,512

(22) Filed: Jan. 9, 2006

(51) Int. Cl. H04B 7/00

(52) U.S. Cl. 370/310

(57) ABSTRACT

The present invention discloses a method for detecting a wireless network signal that sets at least one service set identity in a wireless network signal detector, so that after the wireless network signal detector receives a wireless network signal and identifies that the wireless network signal includes the service set identity, the wireless network signal detector can output a prompt message for facilitating users to determine whether or not the wireless network device is connected to a wireless network.

### FIELD OF THE INVENTION

The present invention relates to a method for detecting a wireless network signal, and more particularly to a method capable of detecting and identifying a wireless network signal connected to the wireless network device that is located within a using range of the wireless network device.

### BACKGROUND OF THE INVENTION

When a wireless Internet service provider constructs a wireless router (such as an access point) in a public area, the public area having the wireless router is called a hot spot, and a wireless network device (such as a notebook computer) can be connected to a wireless network at the hot spot.

In a wireless network, each router has an important function of broadcasting a service set identity (SSID), so that each router can automatically broadcast the service set identity to a wireless network device within a valid range. If it is necessary to add a wireless network device to the router, the same service set identity is needed, or else the wireless Internet service will be rejected. Therefore, not all wireless network devices can be connected directly to the wireless network. If the router is not specified with a service set identity or the router uses a tacitly acknowledged service set identity, then any wireless network device will be able to enter the router. In other words, any wireless network device located within the range of electric waves of the router can receive the radio signal transmitted from the router.

Therefore, each wireless Internet service provider provides a service to consumers who use a wireless network device and make payments by points or monthly payments to connect to the wireless router, so as to avoid the bandwidth of the wireless router from being occupied by other users who have not paid fees to the wireless Internet service provider. In general, each consumer obtains a set of user name, password, and service set identity dedicated to the wireless Internet service provider, so that only such consumer can use the wireless router constructed by the wireless network to connect to the wireless network, and other users cannot use the wireless router of the wireless Internet service provider to connect to the wireless network.

Although a consumer can enter a user name, a password and a service set identity through a hot spot constructed by a wireless Internet service provider, so that the consumer's wireless network device can be connected to the wireless network, yet the consumer cannot know whether or not a hot spot constructed by the wireless Internet service provider is in the consumer's location before turning on the wireless network device. To solve the foregoing problem, several network device manufacturers developed a wireless signal detector as disclosed in R.O.C. Pat. Publication No. M249366, and such wireless signal detector can detect whether or not a wireless network signal exists in a specific range. If the wireless signal detector detects a wireless network signal, the light emitting status of a plurality of light emitting diodes continuously arranged on the surface of the wireless signal detector is used for indicating the intensity of the wireless network signal.

Although the wireless signal detector can detect and display the intensity of the wireless network signal, the wireless signal detector still cannot identify whether or not the detected wireless network signal is transmitted from a wireless router connected by the consumer's wireless network device. If the wireless network signal is not transmitted from a wireless router connected to the wireless network device, then the wireless network device still cannot be connected to the wireless network after the wireless network device is turned on. Therefore, finding a way of identifying the wireless network signal connected to the wireless network device exists within the using range of the wireless network device is a subject that demands immediate attention and feasible solutions.

### SUMMARY OF THE INVENTION

In view of the shortcomings of the prior art, the inventor of the present invention conducted extensive researches and experiments, and finally invented a method for detecting a wireless network signal, in hope of contributing the innovative ideas to the general public.

Therefore, it is a primary objective of the present invention to provide a method for detecting a wireless network signal that sets at least one service set identity in a wireless network signal detector, such that after the wireless network signal detector receives a wireless network signal and identifies that the wireless network signal includes the service set identity, the wireless network signal detector can output a prompt message for facilitating users to determine whether or not the wireless network device is connected to a wireless network.

The above and other objects, features and advantages of the present invention will become apparent from the following detailed description taken with the accompanying drawings.

### BRIEF DESCRIPTION OF THE DRAWINGS

FIG. 1 is a flow chart of the invention;

FIG. 2 is a schematic view of the architecture of a circuit of the invention; and

FIG. 3 is a flow chart of the operation of a preferred embodiment of the invention.

### DETAILED DESCRIPTION OF THE PREFERRED EMBODIMENTS

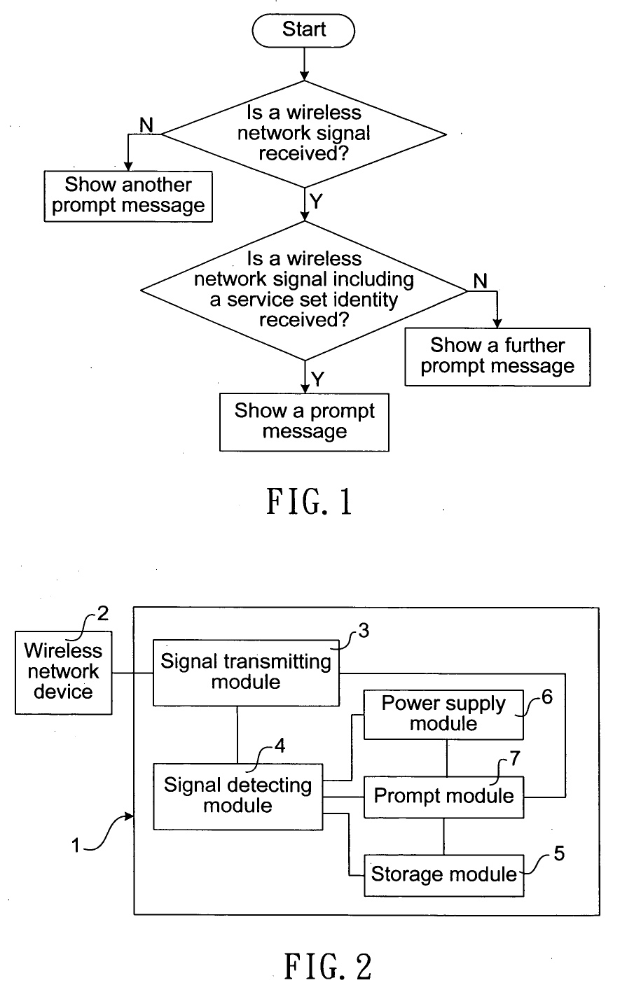

If a wireless router (such as an access point) transmits wireless signals according to the rules of the IEEE802.11 wireless network communication protocol, the access point will send out a beacon from time to time in order to confirm whether or not a wireless network exists, and the beacon includes the service set identity. The present invention uses such characteristic of the wireless router to develop a method for detecting a wireless network signal. Referring to FIGS. 1 and 2, the method sets at least one service set identity in a wireless network signal detector 1, and the wireless network signal detector 1 uses the service set identity to detect and determine whether or not a wireless network signal including a service set identity same as the service set identity can be received at the location of the wireless network signal detector 1. After the wireless network signal having the service set identity is detected, the wireless network signal detector 1 outputs a prompt message to facilitate a user to determine whether or not a wireless network device 2 used by the user can be connected to a wireless network.

In the present invention, if the wireless network signal detector 1 detects no wireless network signal in its location, then the wireless network signal detector 1 will output another prompt message, or if the wireless network signal detector 1 receives a wireless network signal that does not include the service set identity, then the wireless network signal detector 1 will output a further prompt message.

Referring to FIG. 2 for the preferred embodiment of the present invention, the wireless network signal detector 1 comprises a signal transmitting module 3, a signal detecting module 4, prompt module 5, a storage module 6, and a power supply module 7, wherein the signal transmitting module 3 regardless of the wireless network signal detector 1 being connected to the wireless network device 2, the signal transmitting module 3 can receive a wireless network signal transmitted externally. After the wireless network signal detector 1 is connected to the wireless network device 2, the signal transmitting module 3 receives a data sent from the wireless network device 2 and converts the data into a wireless network signal to be sent externally. The signal detecting module 4 detects the signal intensity of a wireless network signal received by the signal transmitting module 3 and produces an intensity signal, and the wireless network signal detector 1 lets the prompt module 5 produce a prompt message according to the intensity signal, and the storage module 6 can store each service set identity set in the wireless network signal detector 1. The power supply module 7 supplies the electric power required by the components of the wireless network signal detector 1.

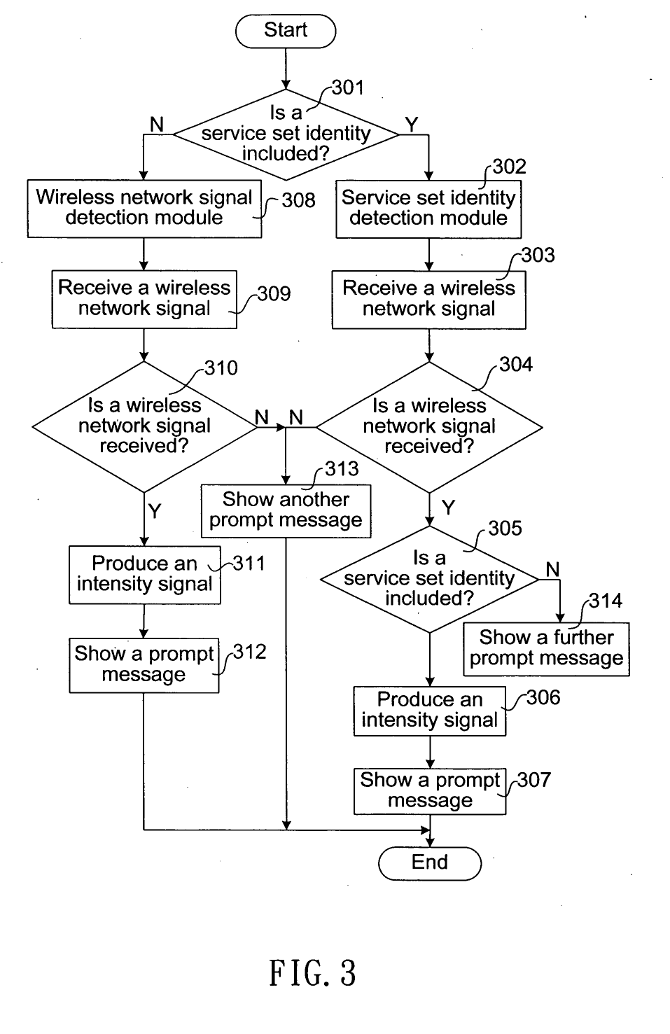

In the preferred embodiment as shown in FIG. 3, the wireless network signal detector 1 uses the signal transmitting module 3, signal detecting module 4, prompt module 5, and storage module 6 to detect whether or not the wireless network signal detector 1 can receive any wireless network signal and determine whether or not the received wireless network signal includes the service set identity, and thus the prompt module 5 outputs each prompt message according to the following steps;

In Step 301, the wireless network signal detector 1 determines whether or not the storage module includes a service set identity. If yes, then carry out the following steps, or else carry out Step 308.

In Step 302, the wireless network signal detector 1 enters into a service set identity detection mode.

In Step 303, the signal transmitting module 3 is used to receive the wireless network signal at the location of the wireless network signal detector 1.

In Step 304, the wireless network signal detector 1 determines whether or not the signal transmitting module 3 has received a wireless network signal. If yes, then carry out the following steps, or else carry out Step 313.

In Step 305, the signal detecting module 4 is used to determine whether or not the wireless network signal includes the service set identity: If yes, carry out the following steps, or else carry out Step 314.

In Step 306, the signal detecting module 4 produces an intensity signal according to the signal intensity of a wireless network signal having a service set identity.

In Step 307, the prompt module 5 produces a prompt message according to the intensity signal, and it ends the procedure.

In Step 308, the wireless network signal detector 1 enters into a wireless network signal detection mode.

In Step 309, the signal transmitting module 3 is used to receive the wireless network signal at the location of the wireless network signal detector 1.

In Step 310, the wireless network signal detector 1 determines whether or not the signal transmitting module 3 has received a wireless network signal. If yes, then carry out the following steps, or else carry out Step 313.

In Step 311, the signal detecting module 4 omits the step of determining whether or not the wireless network signal includes the service set identity, and directly determines the signal intensity of the wireless network signal according to the wireless network signal received by the signal transmitting module 3 to produce an intensity signal.

In Step 312, the prompt module 5 produces the prompt message according to the intensity signal, and it ends the procedure.

In Step 313, the prompt module 5 produces another prompt message, if the signal transmitting module 3 has not received any wireless network signal.

In Step 314, the signal detecting module 4 determines if the wireless network signal does not include the service set identity, and the prompt module produces a further prompt message.

In the preferred embodiment, the prompt module 5 comprises an LED control chip and a plurality of vertically aligned LEDs, and the wireless network signal detector 1 sends a control command to the LED control chip according to the intensity signal, and the LED control chip controls the light emitting status of each LED according to the control command. For example, the prompt message produced by the prompt module 5 shows the signal intensity of a wireless signal according to the number of lit LEDs. Another prompt message and a further prompt module are indicated by unlit LEDs.

From the description above, the wireless network signal detector 1 not only detects and displays the intensity of the wireless network signal, but also identifies whether or not the detected wireless network signal is transmitted from a wireless router connectable from the user end of the wireless network and indicated in each prompt message.

While the invention herein disclosed has been described by means of specific embodiments, numerous modifications and variations could be made thereto by those skilled in the art without departing from the scope and spirit of the invention set forth in the claims.

What is claimed is:

1. A method for detecting a wireless network signal, including at least one service set identity set in a wireless network signal detector, and said wireless network signal detector proceeds with a procedure comprising the steps of:
determining whether or not a wireless network signal having a service set identity same as said service set identity identical can be received; and
outputting a prompt message, if said wireless network signal is received and identified to include the same service set identity.

2. The method of claim 1, wherein said wireless network signal detector outputs another prompt message, if said wireless network signal detector has not received said wireless network signal.

3. The method of claim 2, wherein said wireless network signal outputs a further prompt message, if said wireless network signal does not include a service set identity.

4. The method of claim 3, wherein said wireless network signal detector comprises a signal transmitting module, a signal detecting module, a prompt module, a storage module and a power supply module, said service set identity is stored in said storage module and said wireless network signal detector proceeds with a procedure comprising the steps of:
determining whether or not said storage module includes said service set identity;
entering into a service set identity detection mode, if said storage module includes said service set identity;
enabling said signal transmitting module to receive said wireless network signal;
determining whether or not said signal transmitting module has received said wireless network signal;
enabling said signal detecting module to determine whether or not said wireless network signal includes said service set identity, if said wireless network signal is received;
enabling said signal detecting module to produce an intensity signal according to the signal intensity of said wireless network signal having said service set identity, if said wireless network signal includes said service set identity; and
enabling said prompt module to produce said prompt message according to said intensity signal.

5. The method of claim 3, wherein if said wireless network signal detector determines that said storage module does not include said service set identity, said wireless network signal detector carries the procedure comprising the steps of:
entering into a wireless network signal detection mode;
enabling said signal transmitting module to receive said wireless network signal;
determining whether or not said signal transmitting module has received said wireless network signal;
enabling said signal transmitting module to determine the signal intensity of said wireless network signal and produce an intensity signal, if said signal transmitting module receives said wireless network signal; and
enabling said prompt module to produce said prompt message according to said intensity signal.

6. The method of claim 4, wherein said prompt module produces said other prompt message, if said signal transmitting module has not received said wireless network signal.

7. The method of claim 4, wherein said prompt module produces said other prompt message, if said wireless network signal does not include said service set identity.

8. The method of claim 5, wherein said prompt module produces said further prompt message, if said signal transmitting module has not received said wireless network signal.
